(19) United States
(12) Patent Application Publication
(10) Pub. No.: US 2007/0298063 A1
(43) Pub. Date: Dec. 27, 2007

(54) Equine gnat repellant

(76) Inventor: Riannon Walsh, East Coventry, PA (US)

Correspondence Address: RATNERPRESTIA, P O BOX 980, VALLEY FORGE, PA, 19482-0980, US

(21) Appl. No.: 11/810,317

(22) Filed: Jun. 5, 2007

Related U.S. Application Data
(60) Provisional application No. 60/815,922, filed on Jun. 23, 2006.

(51) Int. Cl. A01N 25/34; A01N 25/00; A01N 65/00

(52) U.S. Cl. 424/403; 424/405; 424/774; 424/778

(57) ABSTRACT

An gnat repellant is provided from one or more active ingredients in a oil base, that is safe and effective over long periods on herd animals and articles worn by animals. A method for repelling gnat in herd animals and treating gnat bites on herd animals is also included.

This application claims priority to U.S. Provisional Patent Application Ser. No. 60/815,922 filed Jun. 23, 2006.

### FIELD OF THE INVENTION

The present invention relates to formulations that are effective for repelling gnats that adversely impact herd animals, methods of repelling gnats and methods of treating gnat bites in herd animals.

### BACKGROUND OF THE INVENTION

Herd animals often suffer from biting insects and parasites. Horses, in particular, are vulnerable to biting insects, including but not limited to, for example, mosquitoes, deer flies, biting gnats or midges (Culicoides) and other egg-laying parasites. Mosquitoes are a serious problem for horses because they transmit encephalitis and West Nile virus. Black flies attack horses' ears and insecticides or salves are required for treatment. Culicoides are among the most abundant of haematophagous insects and occur throughout most of the inhabited world and transmit a great number of assorted pathogens associated with horses. They are vectors of arboviruses in horses and are responsible for many important arboviral diseases in herd animals. Aside from the pain and discomfort to herd animals caused by these pests, there is also the potential for infections, transfer of diseases, weight loss from lack of rest and even death of the herd animal. In addition, the same biting insects and parasites associated with herd animals are often problematic for riders and herd animal handlers.

U.S. Pat. No. 5,711,953 discloses an insect repellant that comprises a garlic extract and a hot pepper extract in a surfactant using vinegar as a carrier solution. One limitation of the insect repellant is that it is composed primarily of biodegradable ingredients, most of which are ordinary food products. It would be beneficial to develop an insect repellant, in particular a gnat repellant, for herd animals, including but not limited to horses, that had improved efficacy under conditions of high humidity or sweat, that is prepared in an oil base to effectively retain the active ingredients and could be placed on articles to act as an gnat repellant.

### SUMMARY OF THE INVENTION

Accordingly, the present invention provides a gnat repellant formulation comprising 10% to 25% by weight of one or more active ingredients selected from essential oils including tea tree oil, oil of cloves and rosemary oil; and 90% to 75% by weight of an oil base, based on the total weight of the formulation.

Further, the present invention also provides articles treated with the gnat repellant formulation.

Additionally, the present invention includes a method of repelling gnats using the repellant formulation. The method further includes the steps of preparing the repellant formulation and applying the formulation to herd animal skin.

Additionally, the present invention includes a method of treating Sweet Itch/Summer Dermatitis using the formulation. The method further includes the steps of preparing the repellant formulation and applying the formulation to bite areas on herd animal skin.

### DETAILED DESCRIPTION OF THE INVENTION

In accordance with the present invention, there is provided a gnat repellant formulation comprising 10% to 25% by weight of one or more from active ingredients selected from essential oils including tea tree oil, oil of cloves and rosemary oil; and 90% to 75% by weight of an oil base, based on the total weight of the formulation. Formulations' according to the present invention may be used as “starter” formulations and/or as “maintenance” formulations.

A suitable oil base is used to prepare the gnat repellant formulation. Oil base, as used herein, refers to any suitable combination of oils that occur naturally or are nature-identical vegetable or animal fatty oils. Suitable oils used in accordance with the oil base of the invention include, but are not limited to, for example, aloe oil, jojoba oil, almond oil, rape-seed oil, sunflower oil, peanut oil, peanut butter, soy oil, safflower seed oil, cuphea oil, coconut oil, palm kernel oil, palm oil and fish oil.

The oil base functions to act as a solvent or carrier for the one or more active ingredients and provides a formulation that is both water repelling and efficacious under conditions of high humidity and sweat. According to one embodiment, certain oils that make up the oil base also include one or more active ingredients, providing a repellant having a synergistic combination of active ingredients. Suitable examples of such oils include, but are not limited to, for example, aloe oil, jojoba oil, eucalyptus oil, cuphea oil, coconut oil, palm kernel oil, palm oil and fish oil.

According to another embodiment, a water proof gnat repellant formulation is provided that is suitable when the herd animal is engaged in work and/or under conditions above 20° C. that comprises an oil base having a petroleum based oil as an additional component. Suitable petroleum based oils include, but are not limited to, for example, Vaseline, white petroleum jelly, paraffin oils, and greases.

One or more active ingredients selected from essential oils are combined with the oil base to provide the gnat repellant formulation for herd animals. Suitable essential oils include, but are not limited to, for example, herbal oils, botanical oils, citronella oil, camphor oil, tea tree oil, oil of cloves, rosemary oil, lemon oil, cedar oil, pennyroyal oil, mint oil, wormwood oil, lavender oil, and southernwood oil.

According to another embodiment, the invention provides a gnat repellant formulation, generally used as a maintenance formulation, including a combination of essential oils. An exemplary formulation includes 1-5% by weight tea tree oil, 1-5% by weight oil of cloves, 3-10% by weight rosemary oil and 80-95% by weight witch hazel oil.

According to one embodiment, the repellant formulation is useful for repelling biting gnats (culicoides). It is also useful for treating Sweet Itch/Summer Dermatitis caused by biting gnats. The repellent formulation is especially useful for horses and other animals, including, but not limited to, for example, dogs.

One advantage of the gnat repellant formulation is that it tolerates conditions of high humidity and perspiration, but does not irritate animal skin or mucous membranes unlike synthetic insect repellents. Another advantage is that the gnat repellant provides an effective repellent for application onto the animal skin from naturally occurring and nature-identical raw materials having minimized toxicological risk and that maintains efficacy over a long period of time. Another advantage is that the repellant provides a therapeutic treatment to gnat bitten areas in the affected animal in addition to its function as a repellant.

According to one embodiment, the one or more active ingredients are combined in a liquid form in the oil base, for ease of preparation of the repellant. The liquid so formed is easily and uniformly applied to the animal and articles worn and used by the animal by spraying, rubbing, wiping, or brushing it onto the surface of the skin, hair, fur, or articles of the animal or handler, using a cloth, a spray bottle, a sponge, or the like. Articles worn and used by the herd animal include, but are not limited to, for example, clothing.

Although the invention is illustrated and described herein with reference to specific embodiments, the invention is not intended to be limited to the details shown. Rather, various modifications may be made in the details within the scope and range of equivalents of the claims and without departing from the invention. The invention is further illustrated in the following examples:

### EXAMPLE 1

### Equine Gnat Repellant Formulation

An equine gnat repellant formulation was prepared from a base oil including 4 parts safflower oil and 2 parts almond oil. To the oil base was added 0.4 parts tea tree oil, 0.6 parts oil of cloves, and 1 part rosemary oil. The formulation is referred to as a starter formulation.

### EXAMPLE 2

### Synergistic Gnat Repellant Formulation

An equine gnat repellant formulation was prepared from a base oil including 4 parts aloe oil and 2 parts jojoba oil. To the oil base was added 0.4 parts tea tree oil, 0.6 parts oil of cloves, and 1 part rosemary oil. The formulation is referred to as an alternative starter formulation.

### EXAMPLE 3

### Maintenance Gnat Repellant Formulation

An equine gnat repellant formulation was prepared from a base oil including 4 parts aloe oil and 5 parts jojoba oil. To the oil base was added 0.4 parts tea tree oil, 0.6 parts oil of cloves, and 1 part rosemary oil. The formulation is referred to as a maintenance formulation.

### EXAMPLE 4

### Maintenance Gnat Repellant Formulation

An equine gnat repellant formulation was prepared by mixing 7 parts witch hazel oil, 0.25 parts tea tree oil, 0.25 parts oil of cloves, and 0.5 parts rosemary oil. The formulation is referred to as an alternative maintenance formulation.

### EXAMPLE 5

### Strenuous Work/Hot Weather Gnat Repellant Formulation

The formulation of Examples 1 or 2 (0.13 parts) was blended into 0.67 parts of white petroleum jelly. The formulation was packed in tubes that were sealed.

### EXAMPLE 6

### Article Containing Gnat Repellant Formulation

A hat and a cloth for wearing around the neck of the animal were treated with small amounts of the formulations from Examples 1 and 2.

General procedure for application to horses. The formulation is applied twice daily, morning and evenings or before any turnout time from spring until autumn. The formulation was applied to horses dorsal line (also referred to as under belly) from sheath/udder to front legs using a softbrush or the palm of a hand. The formulation was also applied to udder, inside of upper back legs, under tail near rectum and down back legs, hair, skin, sores and bitten areas. Very small quantities of the formulation are required for efficacy, enough to visibly discern as covering surface of intended area of use on horse. The formulation was also applied to horse clothing, ears, cheeks and shoulders of the horse.

What is claimed:

1. A gnat repellant formulation comprising:
10% to 25% by weight of one or more active ingredients selected from the group consisting of: tea tree oil, oil of cloves and rosemary oil; and
90% to 75% by weight of an oil base selected from the group consisting of almond oil, safflower oil, jojoba oil and aloe oil, based on the total weight of the formulation.

2. The formulation according to claim 1, wherein the oil base comprises aloe oil and jojoba oil and wherein the active ingredients are tea tree oil, oil of cloves and rosemary oil.

3. The formulation according to claim 1, wherein the oil base further comprises petroleum based oils selected from the group consisting of: white petroleum jelly, paraffin oils, and greases.

4. The formulation according to claim 1, wherein 10 to 18% by weight of the gnat repellant formulation is blended with 82 to 90% by weight of white petroleum jelly.

5. Clothing treated with the gnat repellant formulation of claim 1.

6. A method of repelling gnats comprising:
preparing a gnat repellant formulation comprising:
10% to 25% by weight of one or more active ingredients selected from the group consisting of: tea tree oil, oil of cloves and rosemary oil; and
90% to 75% by weight of an oil base selected from the group consisting of almond oil, safflower oil, jojoba oil and aloe oil, based on the total weight of the formulation; and
applying the formulation to animal skin.

7. The method according to claim 6, wherein the oil base comprises aloe oil and jojoba oil and wherein the active ingredients are tea tree oil, oil of cloves and rosemary oil.

8. The method according to claim 7, wherein 10 to 18% by weight of the gnat repellant formulation is blended with 82 to 90% by weight of white petroleum jelly.

9. A method of treating Sweet Itch/Summer Dermatitis in animals comprising:
preparing a gnat repellant formulation comprising:
10% to 25% by weight of one or more active ingredients selected from the group consisting of: tea tree oil, oil of cloves and rosemary oil; and
90% to 75% by weight of an oil base selected from the group consisting of almond oil, safflower oil, jojoba oil and aloe oil, based on the total weight of the formulation; and
applying the formulation to skin of the animal.

10. The method according to claim 9, wherein the oil base comprises aloe oil and jojoba oil and wherein the active ingredients are tea tree oil, oil of cloves and rosemary oil.

11. The method according to claim 9 wherein the animal is a herd animal.

12. A gnat repellant formulation comprising:
1-5% by weight tea tree oil;
1-5% by weight oil of cloves;
3-10% by weight rosemary oil; and
80-95% by weight witch hazel oil.
